(19) United States
(12) Patent Application Publication
(10) Pub. No.: US 2008/0319663 A1
(43) Pub. Date: Dec. 25, 2008

(54) Method for smart broadcasting of stop names

(75) Inventor: Syuan-Jhe Liao, Taichung (TW)

Correspondence Address: BACON & THOMAS, PLLC, 625 SLATERS LANE, FOURTH FLOOR, ALEXANDRIA, VA, 22314-1176, US

(73) Assignee: CHUNGHWA UNITED TELEVISION CO., LTD, Taichung City (TW)

(21) Appl. No.: 11/812,844

(22) Filed: Jun. 22, 2007

(51) Int. Cl. G01C 21/26; G01C 21/00; G01C 21/10; G01C 21/20

(52) U.S. Cl. 701/213

(57) ABSTRACT

A method for smart broadcasting of stop names includes the steps of using a global positioning device to receive positioning signals transmitted from a satellite to obtain data of current vehicle geographic longitude and latitude coordinates and moving speed, and to compute a distance between the current vehicle position and a next stop based on the obtained current vehicle coordinates and moving speed data; and causing a microprocessor to use analyzed vehicle speed data to compute parameters for adjusting a predicted distance and the predicted distance, so that the microprocessor determines based on the predicted distance and the distance to the next stop whether a broadcasting device is to be actuated or not. Therefore, a mass transportation vehicle running on the same route at different hours in a day may automatically broadcast and timely inform passengers of the next stop name depending on the current vehicle moving speed.

### FIELD OF THE INVENTION

The present invention relates to a method for smart broadcasting of stop names, and more particularly to a method for smart broadcasting of stop names according to a vehicle moving speed.

### BACKGROUND OF THE INVENTION

Most of the mass transportation vehicles, including mass rapid transit (MRT) trains, general trains, airplanes, etc., would broadcast the arrival at a stop via an intra-vehicle broadcasting system, so that passengers on the vehicle are informed of the name and other related information of the next stop. Under normal conditions, these mass transportation vehicles are generally not affected by external factors to change the arrival time at each stop.

City bus is also a type of mass transportation vehicle having very close relation to people's daily life. In the early stages, most city buses have a female bus captain assigned thereto, and the female bus captain informs the passengers of the name of next stop. With the coming of electronic era, an electronic signboard provided in the vehicle has replaced the female bus captain to display the name of next stop. However, city buses are running on the roads in cities. The time required for a city bus to move from a first stop to the next stop on the same route may still change at different time in a day due to different traffic conditions thereof. For example, the city bus would have a relatively slower moving speed at peak hours in the morning and evening, and a relatively faster moving speed at off-peak hours at noon and in the nighttime.

During the peak hours, the roads are jammed with cars, and traffic lights at road intersections are manually controlled by traffic polices to control traffic flows. Under this condition, city buses can only move at a speed much slower than that during the off-peak hours. For most passengers, during the peak hours, the time they have from being notified of the next stop to get ready for getting off is changeable due to different traffic conditions. In the event the bus displays the next stop name too early, passengers would have to wait longer for getting off. On the other hand, when the bus displays the next stop name too late, passengers would have to get off in a hurry.

Therefore, it is tried by the inventor to develop a method for a mass transportation vehicle to timely broadcast the next stop, so that passengers may have sufficient time to get ready for getting off without the risk of rushing to or staying at the bus door.

### SUMMARY OF THE INVENTION

A primary object of the present invention is to enable a mass transportation vehicle, particularly, a city bus, to timely inform passenger of the next stop name, so that passengers may get ready for getting off without the need of rushing to or staying at the bus door.

To achieve the above and other objects, the present invention provides a method for smart broadcasting of stop names. In the method, there are included the steps of using a global positioning device to receive a positioning signal transmitted from a satellite from time to time, to obtain data of current vehicle geographic longitude and latitude coordinates and moving speed from the received positioning signal, and to compute a distance between the current vehicle position and a next stop based on the obtained data of the current vehicle coordinates and moving speed; and causing a microprocessor to receive data of the current vehicle coordinates and moving speed as well as the distance to the next stop, and use vehicle moving speed data to compute parameters for adjusting a predicted distance and a predicted distance, so that the microprocessor determines based on the predicted distance and the distance to the next stop whether a broadcasting device is to be actuated or not. Therefore, a mass transportation vehicle running on the same route at different time in a day may automatically broadcast and timely inform passengers of the next stop name depending on the current vehicle moving speed.

To implement the method of the present invention, the global positioning device has basic vehicle speed data preset therein. Therefore, the global positioning device is able to analyze the current vehicle moving speed data obtained from the positioning signal and the basic vehicle speed data preset in the global positioning device to produce an analyzed speed data, which is then transmitted from the global positioning device to the microprocessor for computing the parameters for adjusting a predicted distance and the predicted distance.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram describing a method for smart broadcasting of stop names according to a preferred embodiment of the present invention;

FIG. 2 is a flowchart showing the steps included in the method for smart broadcasting of stop names according to the preferred embodiment of the present invention; and

FIG. 3 shows example tables recording the time required for a city bus to move between different points on the same route at different hours in a working day and a holiday.

### DETAILED DESCRIPTION OF THE PREFERRED EMBODIMENTS

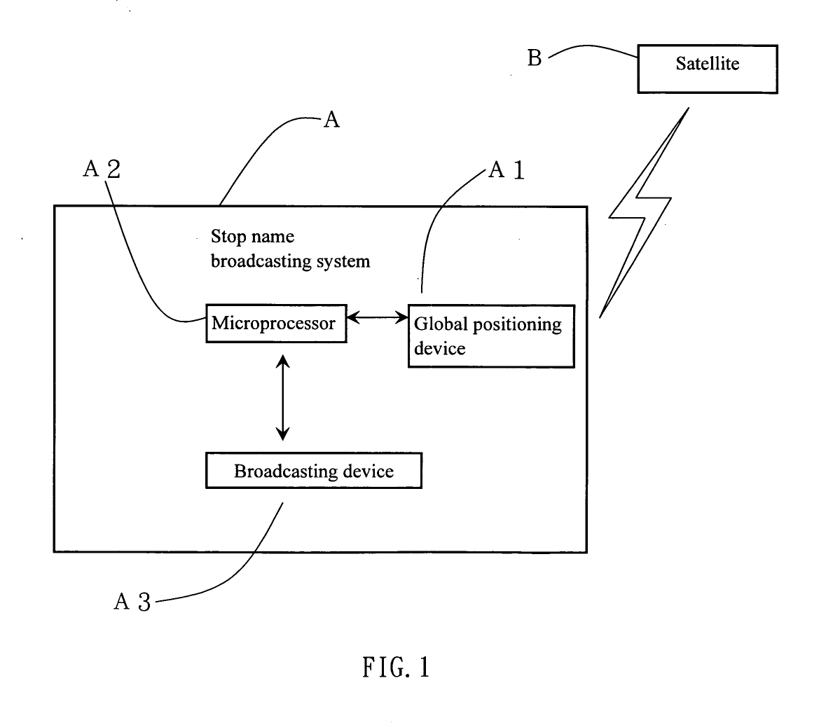

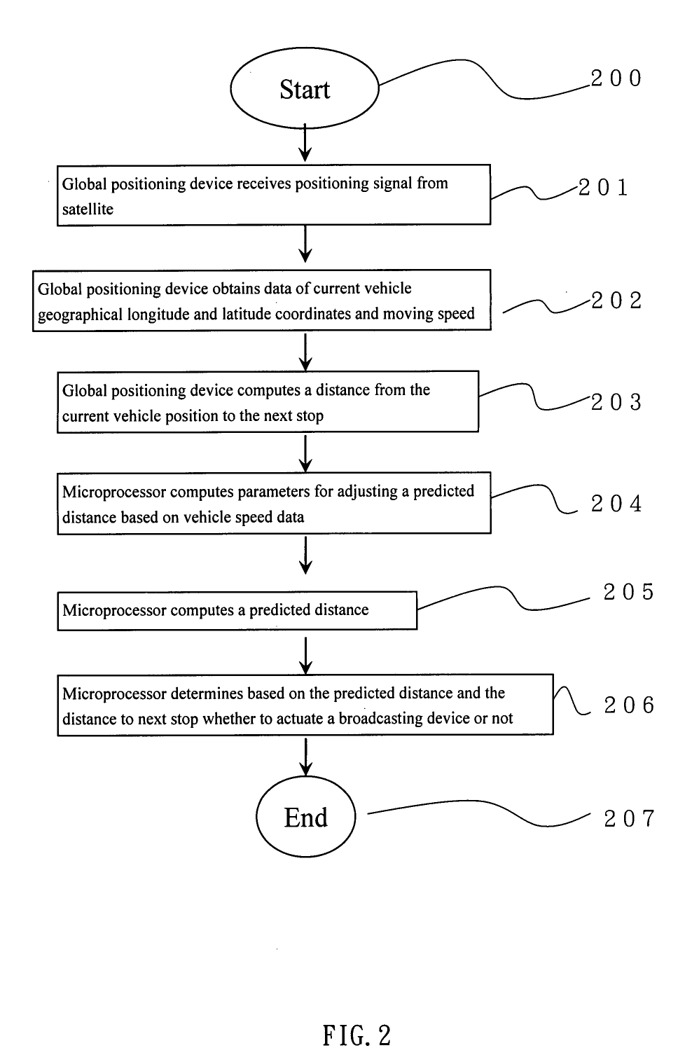

Please refer to FIGS. 1 and 2, which are block diagram and flowchart, respectively, of a method for smart broadcasting of stop names according to a preferred embodiment of the present invention. As can be seen from FIG. 1, to carry out the method of the present invention, there is provided a stop name broadcasting system A, which includes at least one global positioning device A1 having basic vehicle speed data preset therein, at least one microprocessor A2 electrically connected to the global positioning device A1, and at least one broadcasting device A3 electrically connected to the microprocessor A2. The global positioning device A1 is able to transmit and receive signals to and from a satellite B. When using the stop name broadcasting system A to proceed with stop name broadcasting in the method of the present invention, the following steps are included:

Starting the method (step 200);

Using the global positioning device A1 to receive a positioning signal transmitted from the satellite B (step 201);

Using the global positioning device A1 to obtain data of current vehicle geographic longitude and latitude coordinates as well as moving speed (step 202);

Using the global positioning device A1 to compute a distance between the current vehicle position and a next stop (step 203);

Using the microprocessor A2 to compute parameters for adjusting a predicted distance based on the vehicle speed data (step 204);

Using the microprocessor A2 to compute a predicted distance (step 205);

Determining by the microprocessor A2 based on the predicted distance and the distance to the next stop whether the broadcasting device A3 is to be actuated or not (step 206); and

Ending the method (step 207).

To use the method of the present invention to broadcast stop names on a mass transportation vehicle, first establish a signal transmission between the satellite B and the global positioning device A1, so that a positioning signal is transmitted from the satellite B to the global positioning device A1 from time to time. The global positioning device A1 will analyze the received positioning signal to obtain data of current vehicle geographic longitude and latitude coordinates as well as moving speed. Then, the global positioning device A1 starts computing the distance between the current vehicle position and the next stop based on the current vehicle geographic longitude and latitude coordinates and the coordinates of the next stop. After computing the distance, the global positioning device A1 proceeds with analysis of data of current vehicle moving speed and basic vehicle speed. The analyzed speed data and the obtained distance data are transmitted to the microprocessor A2, at where the analyzed speed data is used to compute parameters for adjusting a predicted distance and the predicted distance, so as to determine based on the predicted distance and the distance to the next stop whether the broadcasting device A3 is to be actuated or not. With the above described steps, it is possible to determine the timing for the mass transportation vehicle on the road to broadcast the next stop name based on the current moving speed, so that passengers on the vehicle may be timely informed of the next stop name and get ready for getting off the vehicle.

In computing the parameters for adjusting a predicted distance and the predicted distance, the microprocessor A2 may utilize an artificial neural system or a fuzzy system to control the computing, so that an optimal stop name broadcasting time can be achieved. Since the computing based on an artificial neural system or a fuzzy system belongs to a highly specialized technical field, and is not a subject matter of the present invention, it is not discussed in details herein.

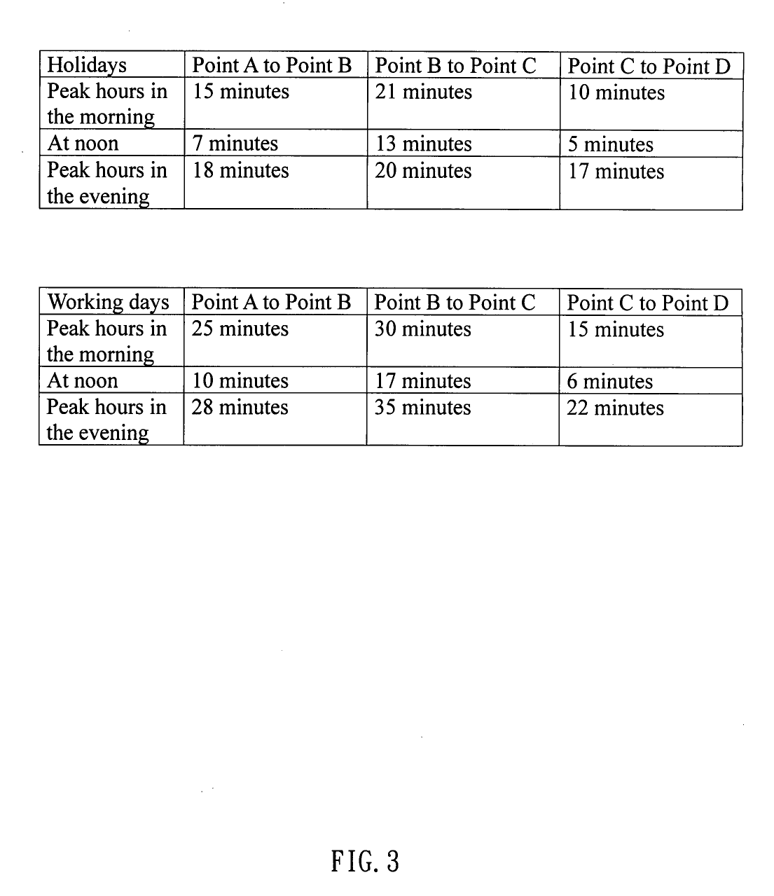

As an example, the method of the present invention for smart broadcasting of stop names on a city bus, a very common mass transportation vehicle, will now be described with reference to FIG. 3. It is supposed a city bus route starts at point A and passes through points B and C to end at point D. As can be seen from the tables in FIG. 3, the time required for the city bus to move from the point A to the point B, from the point B to the point C, and from the point C to the terminal point D changes with different hours in a day and different days. More particularly, for example, the time required for the city bus to move from the point A to the point B is fifteen minutes during morning peak hours in holidays. Therefore, the name of next stop should be broadcasted at 13 or 14 minutes after the city bus has left the point A. And, the time required for the city bus to move from the point A to the point B is twenty-five minutes during morning peak hours in working days. Therefore, the name of the next stop should be broadcasted at 23 or 24 minutes after the bus has left the point A. A main factor that affects the arrival time of the city bus at a stop is the bus moving speed. Even on the same bus route, the bus moving speed differs during different hours due to uncontrollable traffic conditions. Please refer to FIGS. 1 through 3 at the same time. When the city bus is on the road, the global positioning device A1 receives a positioning signal transmitted from the satellite B from time to time and obtains from the positioning signal the current bus geographic longitude and latitude coordinates as well as moving speed, with which the global positioning device A1 further computes the distance from the current bus position to the next stop. The microprocessor A2 receives from the global positioning device A1 data of the above-mentioned current bus geographic longitude and latitude coordinates and moving speed, as well as the computed distance between the current bus position and the next stop, and uses the speed data to compute parameters for adjusting a predicted distance and the predicted distance. From the predicted distance, the microprocessor A2 determines the distance between the current bus position and the next stop, and broadcasts the next stop name suitably before the arrival of the city bus at the next stop. That is, the next stop name is automatically broadcasted on the bus at a right time, so that passengers on the city bus are timely informed of the arrival at the next stop.

In conclusion, the present invention advantageously provides a method for smart broadcasting of stop names, enabling passengers on a mass transportation vehicle to timely know the next stop name and have sufficient time to get ready for getting off. Therefore, the vehicle provides the passengers with more conveniences in riding the vehicle. Moreover, since the next stop name is automatically broadcasted via the stop name broadcasting system A, it is not necessary for the vehicle driver to personally operate the broadcasting device or pay attention to the timing of the broadcasting during driving. Therefore, the driver is allowed to concentrate in driving to ensure the safety of passengers.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A method for smart broadcasting of stop names according to vehicle moving speed, comprising the steps of:
using a global positioning device to receive a positioning signal transmitted from a satellite from time to time;
using the global positioning device to obtain data of current vehicle geographic longitude and latitude coordinates and moving speed from the received positioning signal;
using the global positioning device to compute a distance between the current vehicle position and a next stop based on the data obtained in the preceding step;
causing a microprocessor to use analyzed vehicle speed data received from the global positioning device to compute parameters for adjusting a predicted distance;
using the microprocessor to compute a predicted distance; and
using the microprocessor to determine based on the predicted distance and the distance to the next stop whether a broadcasting device is to be actuated or not.

2. The method for smart broadcasting of stop names as claimed in claim 1, wherein the global positioning device has basic vehicle speed data preset therein, and the current vehicle moving speed and the basic vehicle speed data are analyzed by the global positioning device to obtain the analyzed speed data, which is then transmitted from the global positioning device to the microprocessor.

3. The method for smart broadcasting of stop names as claimed in claim 1, wherein the microprocessor utilizes an artificial neural system or a fuzzy system to control the computing of the parameters for adjusting a predicted distance and the predicted distance, so as to enable the broadcasting of a next stop name at an optimal time.

4. The method for smart broadcasting of stop names as claimed in claim 1, wherein the method is carried out via a stop name broadcasting system, which includes at least one global positioning device having basic vehicle speed data preset therein, and at least one microprocessor electrically connected to the global positioning device; and at least one broadcasting device electrically connected to the microprocessor.
